(19) United States
(12) Patent Application Publication
(10) Pub. No.: US 2007/0224021 A1
(43) Pub. Date: Sep. 27, 2007

(54) Rapid-assembly earth retaining device

(75) Inventor: Giulio Travi, Colico (Co) (IT)

Correspondence Address: K.F. ROSS P.C., 5683 RIVERDALE AVENUE, SUITE 203 BOX 900, BRONX, NY, 10471-0900, US

(73) Assignee: G. S.r.l.

(21) Appl. No.: 11/725,431

(22) Filed: Mar. 19, 2007

(30) Foreign Application Priority Data
Mar. 27, 2006 (IT) M12006A000571

(51) Int. Cl. A01D 85/00; B60P 3/00; A01D 90/00

(52) U.S. Cl. 414/24.5; 414/460

(57) ABSTRACT

Earth retaining device, comprising a pair of feet (10) for resting on the ground, inside each of which at least one associated upright (20) is inserted, said feet (10) being arranged at a suitable relative distance in the transverse direction (Y-Y) so as to allow the mounting of retaining boards (40) on the uprights (20) and the fitting of bases (50) extending in the transverse direction (Y-Y) between the feet (10).

The present invention relates to a device for retaining and consolidating earth, in particular in the event of landslides, landslips, avalanches and the like.

It is known in the technical sector relating to public repair works following landslides or landslips that there exists the need to perform earth retention work in order to ensure consolidation of the front edge of the landslide, restoration of the accessibility for traffic and reinforcement of a bank.

It is also known that these works must be performed as quickly as possible, whereas the works according to the present state of the art, because of their nature, inevitably involve very long execution times due to not only surveying of the terrain, design of structures and contracting of the work to a specialized company, but also carrying out of excavation and consolidation work, the laying of foundations, reinforcement irons and shutterwork, and finally the casting of concrete which in turn must be allowed time to “cure” in order to achieve the necessary resistance to the movement of the ground.

The technical problem which is posed, therefore, is to provide a device for retaining and consolidating earth which is particularly suitable for rapid use in the event of landslides, landslips and the like, being simple and easy to prepare without the need for structural calculations, laying of foundations and the like.

Within the context of this problem it is also required that this device should have small dimensions, be easy and inexpensive to produce and assemble/disassemble and be able to be transported and installed easily using normal standardized connection means.

These results are achieved according to the present invention by an earth retaining device comprising a pair of feet for resting on the ground, inside each of which at least one associated upright is inserted; said feet are arranged at a suitable relative distance in a transverse direction so as to allow the mounting of retaining boards on the uprights and the fitting of bases extending in the said transverse direction.

Further details may be obtained from the following description of a non-limiting example of embodiment of the subject of the present invention provided with reference to the accompanying drawings, in which:

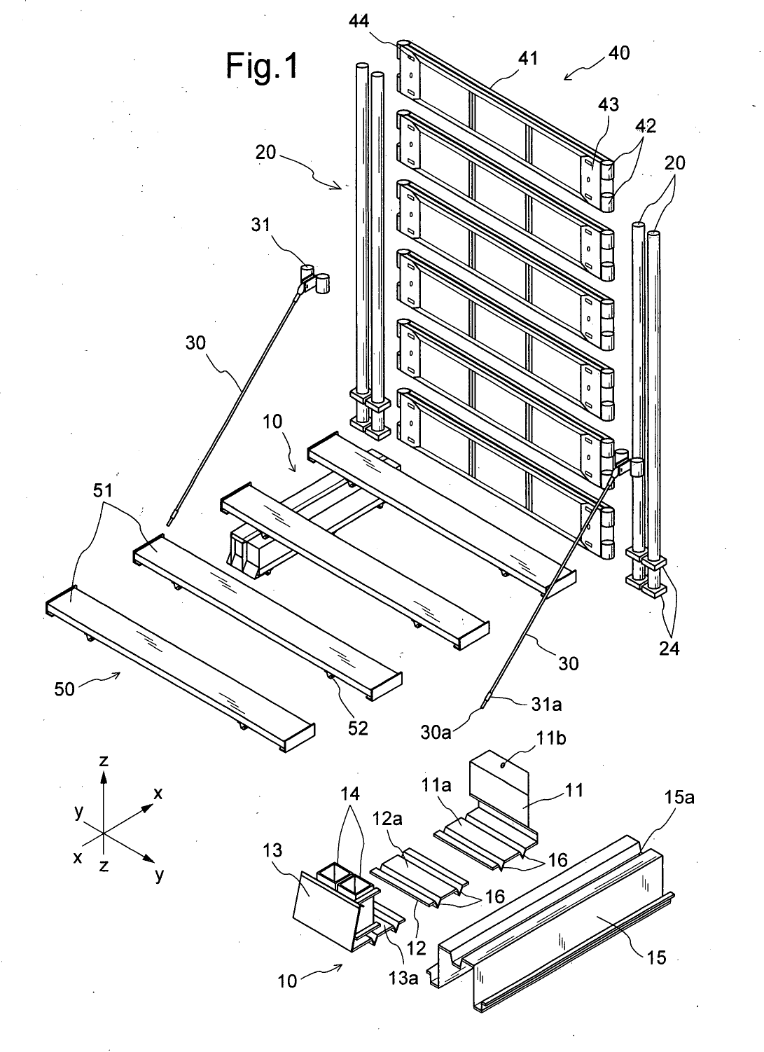

FIG. 1 shows an exploded below of the retaining device according to the present invention;

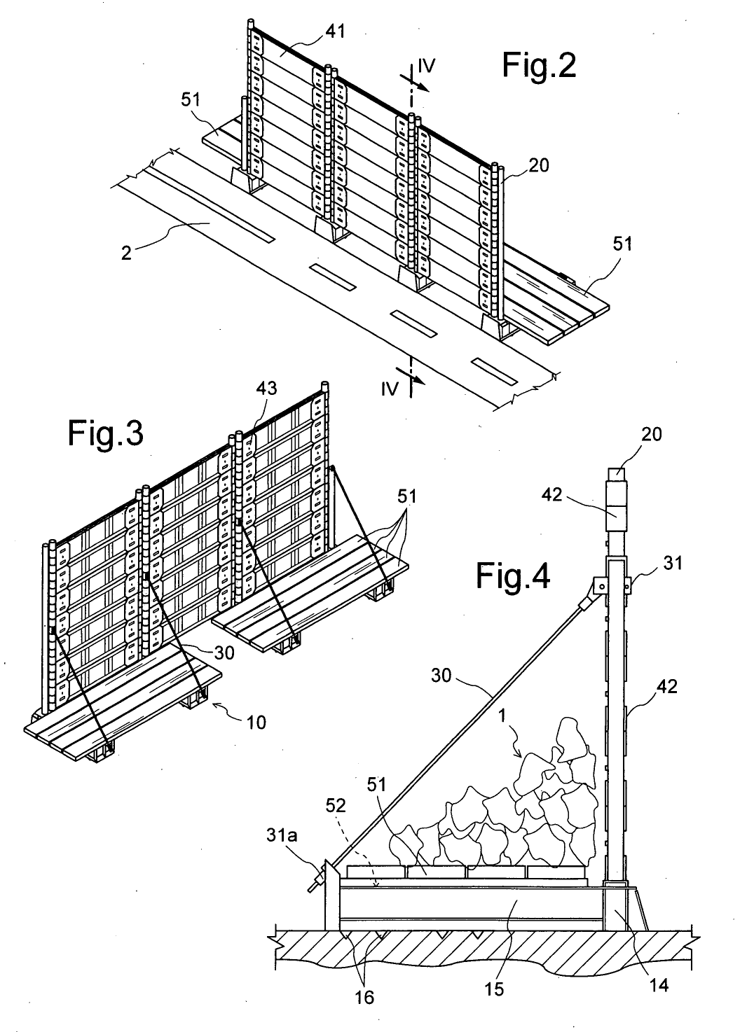

FIG. 2 shows a perspective view, from the front, of the device according to FIG. 1;

FIG. 3 shows a perspective view, from the rear, of the device according to FIG. 1;

FIG. 4 shows a schematic cross-section along the plane indicated by IV-IV in FIG. 2;

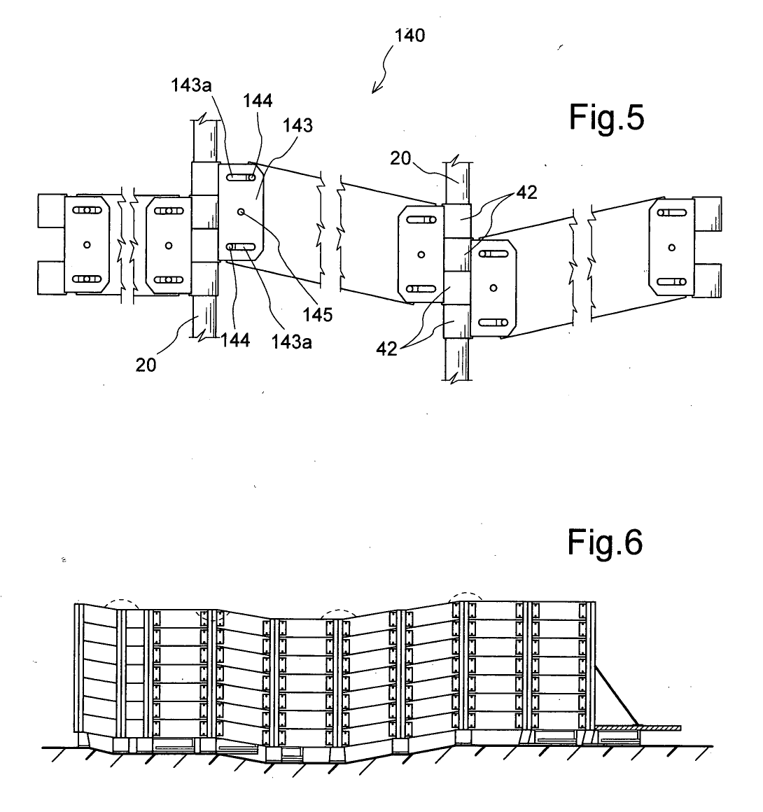

FIG. 5 shows a partial front view of an example of a variation of embodiment of the retaining boards; and

FIG. 6 shows a perspective view, from the front, of the device with the retaining boards according to FIG. 5.

As illustrated in FIG. 1 and assuming, solely for the sake of convenience of the description and without limiting the meaning, a set of three reference axes in a longitudinal direction X-X, transverse direction Y-Y and vertical direction Z-Z as well as a rear part corresponding to the uphill part in contact with the front edge of the landslide and a front part opposite to the rear part, the device for retaining and consolidating landslides, avalanches and the like according to the invention comprises essentially a pair of feet 10 for resting on the ground, inside each of which at least one upright 20 (two in the example shown) can be inserted.

Said feet 10 are arranged at a suitable relative distance in the transverse direction Y-Y so as to allow the mounting of vertical boards 40 on the uprights 20 and the fitting of a base 50 comprising boards 51 in turn extending in the transverse direction Y-Y between the feet 10.

In greater detail, said feet 10 form a single body comprising a rear element 11, a middle element 12 and a front element 13 with respective horizontal sides 11a, 12a, 13a for resting on the ground, provided with teeth 16 able to be inserted in the ground.

Said elements 11, 12, 13 are also fastened by means of welding to an upper closing section 15 provided with an associated seat 15a.

The rear element 11 and front element 13 are substantially bent in the form of an L and the rear element 13 is provided with at least one seat 14 (two in the example of the figures) extending in the vertical direction Z-Z and able to receive the bottom part of the respective upright 20.

According to a preferred embodiment, said seats 14 have a polygonal cross-section and are able to co-operate with corresponding elements 24 which have the same shape and are fitted to the base of the upright 20 which is preferably in the form of a column with a circular cross-section.

The vertical side of the rear “L” 11 is provided with a hole lib able to receive the free end 30a of a tie-rod 30, but prevent passing through of a slider piece 31a which is fastened to the tie-rod and can be locked thereon for tensioning of the latter.

Said vertical boards 40 have opposite flanks which can be inserted inside corresponding flanges 43 from which bushes 42 project towards the outside, said bushes 42 being suitable for coaxial mounting on the columns 21 so as to form the front side of the device; said bushes 42 have an inner diameter which is slightly greater than the outer diameter of the columns 20 so as to allow easy engagement in the vertical direction and rotation of the board 40 about the column 20, in order to allow the arrangement of several devices alongside each other also at relative angles which are variable depending on the actual requirements (FIG. 6).

In a preferred embodiment shown in FIG. 5 said end flanges 143 are connected to the vertical boards 40 by means of a central pin 145 which is fixed and two pins 144 which are seated inside an associated eyelet 143a in the flange 143 inside which they can be displaced and may rotate; with this configuration the board is able to rotate about the fixed pin 145, being arranged at a certain angle of inclination with respect to the horizontal plane X-Y, essentially allowing (FIG. 6) a variation in the height of the device depending on variations in level of the ground.

The end of the tie-rod 30 opposite the slider piece 31a is fastened to at least one ring 31 (two rings in the example shown) which are able to be seated coaxially between said bushes 42 of a predefined board 40 for mounting on the respective upright 20 on which it is stably positioned at the height defined by the prechosen slat 40.

The bottom boards 51 have teeth 52 extending outwards and suitable for insertion in the aforementioned seat 15a of the shaped closing section 15 of the foot 10 so as to achieve a stable relative connection.

With the configuration described, the operating principle of the device is as follows:

after positioning the preassembled feet 10 said feet are placed on the ground;

a pair of bottom beams 51 are rested with the respective engaging members 52 inside the seat 15a of the foot so as to define the correct relative distance;

the uprights 20 are inserted inside the respective seats 14 of the feet 10;

the bushes 42 of the vertical boards 40 are mounted on the uprights up to the height defined for the tie-rod 30;

the rings 31 are inserted between the bushes 42 of the prechosen slat 40 and the bushes 42 and the rings 31 are mounted coaxially on the respective upright 20 as required by the particular situation;

the tie-rods 30 are tensioned by inserting the free end inside the hole 11a and moving upwards and then locking the slider piece 31a;

the front side is then completed by inserting the slats 40 up to the height required for the case in question;

laying of the bottom beams 51 is completed;

the waste material 1 is deposited on the rear base 50 of the device, ensuring the gradual stability of the said device and avoiding the costly operations of loading and transporting to a dump the waste material which is instead completely reused.

Where required, it is possible to use the boards 141 with rotating ends so as to be able to adapt easily to the different variations in height of the land which are typical of the front edge of a landslide which has varying positive and negative inclinations with respect to the horizontal surface.

In this way and as shown in FIG. 2, the front part of the device remains aligned, for example, with a road 2, while the rear part is kept stably positioned by the weight of the material placed on its base.

It is envisaged, moreover, that in the event of a relatively low front edge, the tie-rods 30 may not be fitted between the upright and foot.

It can therefore be seen how the device according to the invention can be rapidly installed on-site, is safe and is extremely flexible.

Unlike the walls of the prior art, structural calculations for installation are not required, completely eliminating the time required for surveying and designing; no time is lost for preparation (foundations, laying of irons and shutterwork, concrete casting, removal of shutterwork) as in conventional structures since assembly requires a few minutes in order for the device to be fully operative.

In addition to this the device according to the present invention may be easily assembled and disassembled and transported on relatively light and manoeuvrable vehicles and may be positioned on-site by workers without any specific training since the individual preconstructed components allow only one possibility for assembly being then able to be gradually disassembled as the work is completed.

1. Earth retaining device for landslides and the like, characterized in that it comprises a pair of feet (10) for resting on the ground, inside each of which at least one associated upright (20) is inserted, said feet (10) being arranged at a suitable relative distance in the transverse direction (Y-Y) so as to allow the mounting of retaining slats (40) on the uprights (20) and the fitting of bases (50) extending in the transverse direction (Y-Y) between the feet (10).

2. Device according to claim 1, characterized in that it comprises a tie-rod (30) arranged between the upright (20) and the foot (10).

3. Device according to claim 1, characterized in that said feet (10) have a surface for restring on the ground, provided with projecting teeth (16) able to be inserted in the ground.

4. Device according to claim 1, characterized in that said feet (10) comprise a rear element (11), a middle element (12) and a front element (13) which are fastened together in the longitudinal direction (X-X).

5. Device according to claim 4, characterized in that said rear element (11) and said front element (13) are substantially bent in the form of an “L”.

6. Device according to claim 4, characterized in that said rear element (13) comprises at least one seat (14) extending in the vertical direction (Z-Z) and able to receive the bottom part of the upright (20).

7. Device according to claim 6, characterized in that said uprights (20) have a circular cross-section.

8. Device according to claim 7, characterized in that said uprights (20) have elements (24) with a polygonal shape fitted to the base thereof.

9. Device according to claim 8, characterized in that said seats (14) for the uprights (20) have a polygonal cross-section corresponding to that of the bottom elements of the upright (20).

10. Device according to claim 1, characterized in that said foot (10) comprises a closing section (15) provided with a corresponding longitudinal seat (15a).

11. Device according to claim 1, characterized in that said foot (10) has a hole (11a) on its rear side for receiving the free end (30a) of the tie-rod (30).

12. Device according to claim 11, characterized in that said hole (11a) has a diameter such as to prevent passing through of a slider piece (31a) which is fastened to the tie-rod and can be locked thereon so as to tension it.

13. Device according to claim 1, characterized in that said tie-rod (30) has an end opposite to that of the slider piece (31a) which is joined to at least one ring (31) able to be mounted on the upright (20).

14. Device according to claim 1, characterized in that said vertical boards (40) have opposite flanks which are inserted in corresponding flanges (43;143) from which bushes (42) able to be mounted coaxially on the uprights (20) project outwards.

15. Device according to claim 14, characterized in that said bushes (42) have an inner diameter which is slightly greater than the outer diameter of the columns (20).

16. Device according to claim 14, characterized in that said bushes (42) have a relative distance in the vertical direction (Z-Z) such as to allow insertion of the end ring (31) of the tie-rod (30).

17. Device according to claim 14, characterized in that said end flanges (143) are connected to the vertical boards (40) by means of a fixed central pin (145) and two pins (144) seated inside an associated eyelet (143a) of the flange (143) inside which they may can be displaced and may rotate.

18. Device according to claim 1, characterized in that said bottom boards (51) have teeth (52) extending outwards and able to be inserted inside a corresponding seat (15a) in the foot (10).
